(19) United States
(12) Patent Application Publication
(10) Pub. No.: US 2005/0136380 A1
(43) Pub. Date: Jun. 23, 2005

(54) Endosseous dental implant

(76) Inventor: Gerald A. Niznick, Las Vegas, NV (US)

Correspondence Address: BRIGHT & LORIG, Suite 3330, 633 West Fifth Street, Los Angeles, CA, 90071, US

(21) Appl. No.: 10/741,061

(22) Filed: Dec. 19, 2003

(51) Int. Cl. A61C 8/00

(52) U.S. Cl. 433/173

(57) ABSTRACT

Endosseous dental implants include an at least partly, externally-threaded body portion, an internal cavity or shaft with an opening to the cavity or shaft at the top surface of the implant, and, in the internal cavity or shaft, a threaded portion, multi-pointed/sided, or multi-slotted wrench-engaging surfaces and tri-lobed surfaces.

This invention relates to endosseous dental implants comprising an, at least partly, externally-threaded body portion, and in some embodiments, an unthreaded external top portion. These implants also comprise an internal cavity or shaft with an opening to the cavity or shaft at the top surface of the implant. This internal cavity or shaft comprises a threaded portion, which begins in the internal cavity or shaft below the top surface of the implant, and ends in the internal cavity or shaft, inside the body portion. The body portion may be cylindrical, conical, or tapered, and may include external, self-tapping threads on the body portion.

The internal cavity or shaft includes a wrench-engaging surface that, in preferred embodiments, comprises surfaces forming three points or apexes or slots equally spaced from one another by 120 degrees, representing the points of a triangle, or, alternatively, three alternate points of an equal sided hexagon. The three-pointed/slotted wrench-engaging surfaces start at or below the top surface and extend into the internal cavity or shaft. The wrench-engaging surfaces are adapted to receive and engage a complementary insertion tool for insertion of the implant into an opening or bore formed in the jawbone of a patient.

The internal cavity or shaft also comprises multi-lobed, preferably three-lobed, surfaces, formed in the internal cavity or shaft. The preferred three lobes of this abutment-engaging surface are positioned between the three points or apexes of the wrench-engaging surface. The preferred tri-lobed surfaces can be formed above, below or in substantially the same plane, or area, as the wrench-engaging surfaces.

In preferred embodiments, the wrench-engaging surfaces have their three points/sides/slots in an area that is smaller than, larger than or substantially the same size as the area in which the three lobes are located. In such preferred embodiments, the internally-threaded portion of the internal cavity or shaft lies below the wrench-engaging surfaces and the tri-lobed surfaces.

The threaded portion of the internal cavity of the implant may be substantially the same in cross-sectional area as the internal wrench-engaging surfaces, or may be smaller in cross-section than either the wrench-engaging or tri-lobed surfaces.

The opening to the internal cavity or shaft of the implant may be chamfered or beveled, preferably all around the opening. The chamfered or beveled portion is, in some embodiments, of sufficient size and shape to receive and engage any abutment, adapter or other connector inserted into the opening. When the opening to the internal cavity or shaft is chamfered/beveled, a complementary adapter, connector or abutment can, in some embodiments, form a smooth, easily cleaned margin between the implant and the abutment, adapter, or connector.

The internal cavity or shaft of the dental implant is, in preferred embodiments, complementary in size and shape to abutments, adapters or other connectors, especially two-part abutments, adapters or other connectors. The abutment may be a dental component such as a healing cap, or impression post, or a temporary or more permanent abutment. In preferred embodiments, such abutments engage the tri-lobed surfaces, may also engage the three-pointed wrench-engaging surfaces, and may have an inner bore that extends through the center of the abutment, with a flange or seat formed in this inner bore. Such a flange or seat supports a threaded screw which fits into and through the inner bore of the abutment, and extends beyond the inner bore for engagement with the internal threads of an implant. In preferred embodiments, these implants have a length in the range of about 8 mm to about 20 mm, and an outer diameter in the range of about 3 mm to about 7 mm. The internal cavity or shaft preferably has a length in the range of about 4 mm to about 8 mm, and a cross-section (or plurality of cross-sections) in the range of about 1.5 mm to about 3.5 mm.

### BRIEF DESCRIPTION OF THE DRAWINGS

The present invention can better be understood from the following detailed description of a preferred embodiment of the invention, taken in conjunction with the accompanying drawings, in which like reference symbols refer to like parts, and in which:

FIG. 1 is a perspective view of a preferred embodiment of the endosseous dental implant;

FIG. 2 is a cross-sectional view of the implant shown in FIG. 1, taken on line 2-2 of FIG. 1;

FIG. 3 is a top plan view of the implant shown in FIGS. 1 and 2;

FIG. 4 is a perspective view of a second preferred embodiment of the endosseous dental implant;

FIG. 5 is a cross-sectional view of the implant shown in FIG. 4, taken on line 2-2 of FIG. 4

FIG. 6 is a top plan view of the implant shown in FIGS. 4 and 5;

FIG. 7 is a perspective view of a third preferred embodiment of the endosseous dental implant;

FIG. 8 is a cross-sectional view of the implant shown in FIG. 7, taken on line 2-2 of FIG. 7;

FIG. 9 is a top plan view of the implant shown in FIGS. 7 and 8;

FIG. 10 is a perspective view of a fourth preferred embodiment of the endosseous dental implant;

FIG. 11 is a cross-sectional view of the implant shown in FIG. 10, taken on line 2-2 of FIG. 10;

FIG. 12 is a top plan view of the implant shown in FIGS. 10 and 11.

### DESCRIPTION OF THE PREFERRED EMBODIMENT

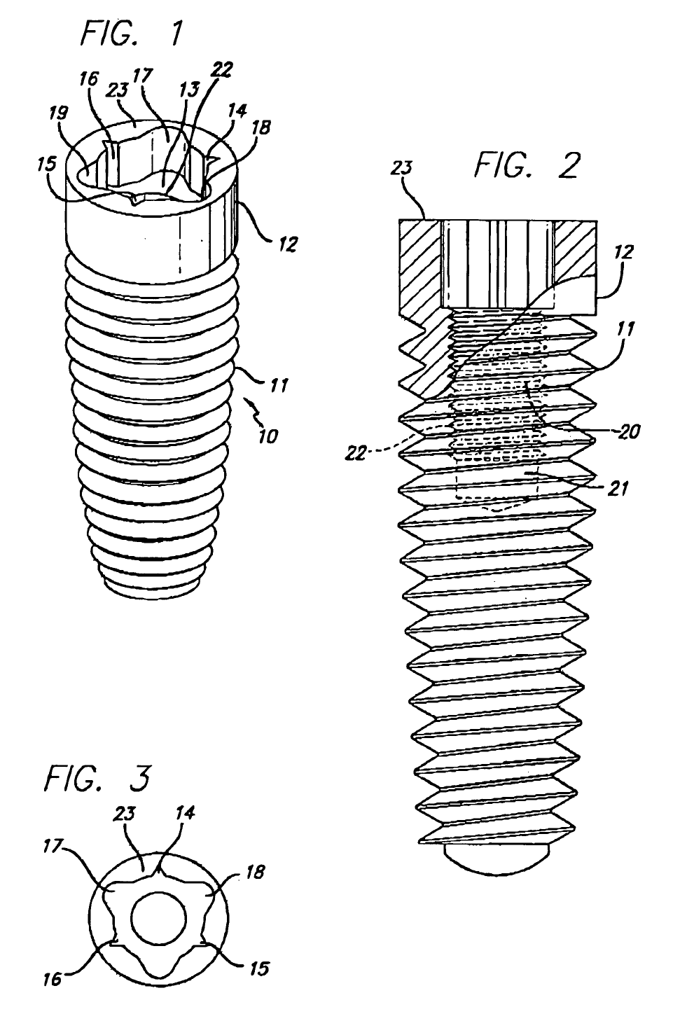

FIG. 1 shows endosseous dental implant 10 with external threading 11 over more than half the length of the external surface of implant 10, and with upper unthreaded external body portion 12. Together, external body portions 11 and 12 comprise the entire external body portion of implant 10. At the top of implant 10 is top surface 23. Below top surface 23 and internal to implant 10 is internal cavity or shaft 22. Opening 13 in top surface 23 of implant 10 leads inwardly and downwardly to internal cavity or shaft 22. Cavity 22 includes (See FIG. 2) threaded portion 20, and, below portion 20, unthreaded portion 21. Threaded portion 21 terminates in passage 22 inside implant 10.

Starting at and extending below top surface 23 are internal wrench-engaging surfaces 14, 15, and 16, which comprise three apexes of an internal triangle formed in passage 22. These apexes 14, 15, and 16 are adapted to receive and engage a three-sided or other wrench-engaging tool for insertion of implant 10 into an opening or bore formed in the jawbone of a patient by threading or screwing implant 10 into such an opening or bore.

Starting at and extending below top surface 23, and internal to implant 10 are tri-lobed surfaces 17, 18, and 19, which are formed in substantially the same plane (or substantially above or below the plane) within which apexes 14, 15, and 16 lie. This tri-lobed surface has rounded surfaces which lie within an area that is substantially greater or smaller in size than the area within which apexes 14, 15, and 16 lie, and/or than the area occupied by the internally threaded portion 20. The tri-lobed surfaces 17, 18, and 19 are adapted to receive and engage an abutment, and may be denoted as abutment-engaging or adapter-engaging surfaces. The external threading 11 on the external surface of implant 10 may be a multiple-lead thread, e.g. a double or triple lead thread, as described in U.S. Pat. No. 5,591,029, columns 14 and 15, or a combination of single and multiple lead threads. The text and drawings of the '029 patent are hereby incorporated by reference in full as though fully set forth here, as are the text and drawings of U.S. Pat. No. 4,960,381, issued Oct. 2, 1990, entitled “Screw-Type Dental Implant Anchor”. The '029 patent is entitled “Dental Implant System”, issued Jan. 7, 1997, and reissued as RE 37,646 on Apr. 9, 2002.

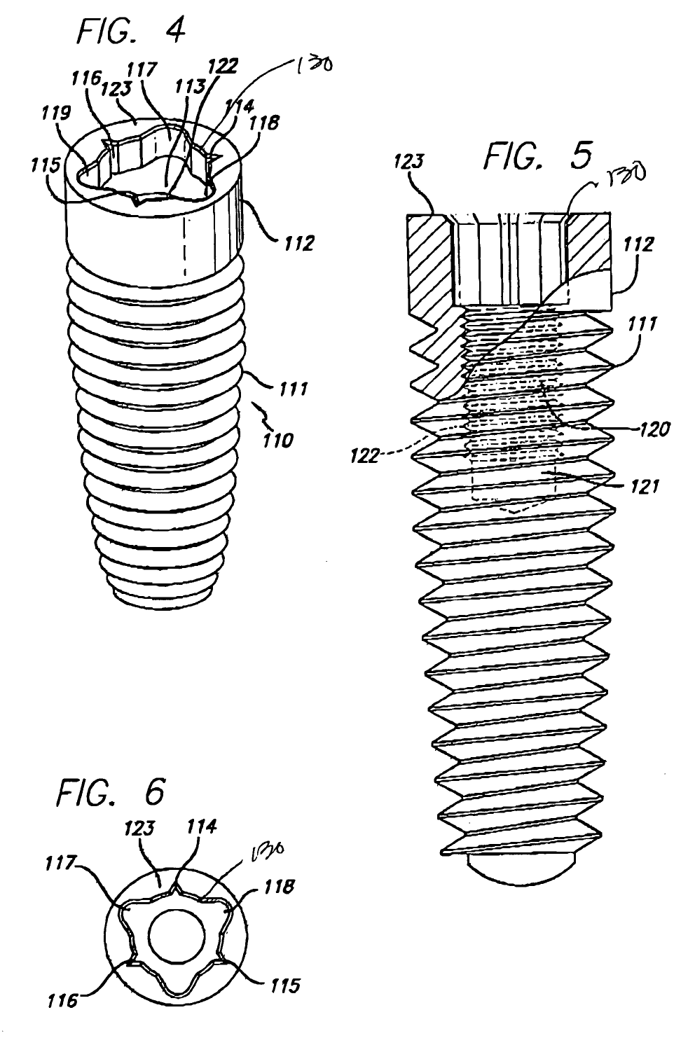

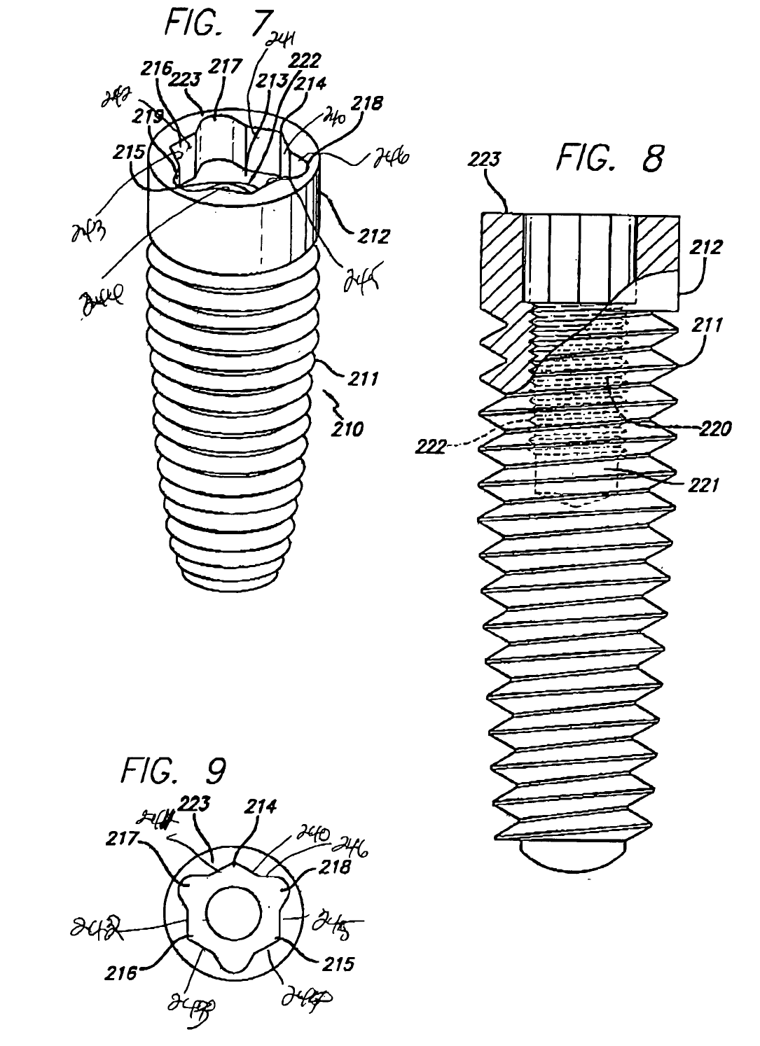

FIG. 4 shows endosseous dental implant 110 with external threading 111 over more than half the length of the external surface of implant 110, and with upper unthreaded external body portion 112. Together, external body portions 111 and 112 comprise the entire external body portion of implant 110. At the top of implant 110 is top surface 123. Below top surface 123 and internal to implant 110 is internal cavity or shaft 122. Opening 113 in top surface 123 of implant 110 leads inwardly and downwardly to internal cavity or shaft 122. At the edge of opening 113 is bevel/chamfer 130, which extends all around opening 113, but could extend only partly around opening 113. Cavity 122 includes (See FIG. 2) threaded portion 120, and, below portion 120, unthreaded portion 121. Threaded portion 121 terminates in passage 122 inside implant 110.

Substantially entirely below top surface 123 are internal wrench-engaging surfaces 114, 115, and 116, which comprise three apexes of an internal triangle formed in passage 122. These apexes 114, 115, and 116 are adapted to receive and engage a three-sided or other wrench-engaging tool for insertion of implant 110 into an opening or bore formed in the jawbone of a patient by threading or screwing implant 110 into such an opening or bore.

Also internal to implant 110 are tri-lobed surfaces 117, 118, and 119, which are formed in substantially the same plane (or substantially above or below the plane) within which apexes 114, 115, and 116 lie. These tri-lobed surfaces have rounded surfaces which lie within an area that is substantially greater than or smaller than the area within which apexes 114, 115, and 116 lie, and/or than the area occupied by the internally threaded portion 120. The tri-lobed surfaces 117, 118, and 119, and non-circular bevel/chamfer 130, are adapted to receive and engage an abutment, and may therefore be denoted abutment-engaging or adapter-engaging surfaces. The external threading 111 on the external surface of implant 110 may be a single or, alternately a multiple-lead thread, e.g. a double or triple lead thread, as described in U.S. Pat. No. 5,591,029, columns 14 and 15, or a combination of single and multiple lead threads.

FIG. 7 shows endosseous dental implant 210 with external threading 211 over more than half the length of the external surface of implant 210, and with upper unthreaded external body portion 212. Together, external body portions 211 and 212 comprise the entire external body portion of implant 210. At the top of implant 210 is top surface 223. Below top surface 223 and internal to implant 210 is internal cavity or shaft 222. Opening 213 in top surface 223 of implant 210 leads inwardly and downwardly to internal cavity or shaft 222. Cavity 222 includes (See FIG. 2) threaded portion 220, and, below portion 220, unthreaded portion 221. Threaded portion 221 terminates in passage 222 inside implant 210.

Starting at and extending below top surface 223 are internal wrench-engaging surfaces 240-246. These surfaces include sides 240, 241, 242, 243, 244, 245, and 246, and the corresponding points formed by these sides, form a multi-pointed wrench-engaging surface, and are adapted to receive and engage alternate points of a hex-shaped or other wrench-engaging tool for insertion of implant 210 into an opening or bore formed in the jawbone of a patient by threading or screwing implant 210 into such an opening or bore.

Also internal to implant 210 are tri-lobed surfaces 217, 218, and 219, which are formed in substantially the same plane (or substantially above or below the plane) within which sides 240-246 lie. These tri-lobed surfaces have rounded surfaces which lie within an area that is substantially greater than or smaller than the area within which sides 240 to 246 lie, and/or than the area occupied by the internally threaded portion 220. Tri-lobed surfaces 217, 218, and 219 are adapted to receive and engage an abutment, and may therefore be denoted abutment-engaging or adapter-engaging surfaces. The external threading 211 on the external surface of implant 210 may be a multiple-lead thread, e.g. a double or triple lead thread, as described in U.S. Pat. No. 5,591,029, columns 14 and 15, or a combination of single or multiple lead threads.

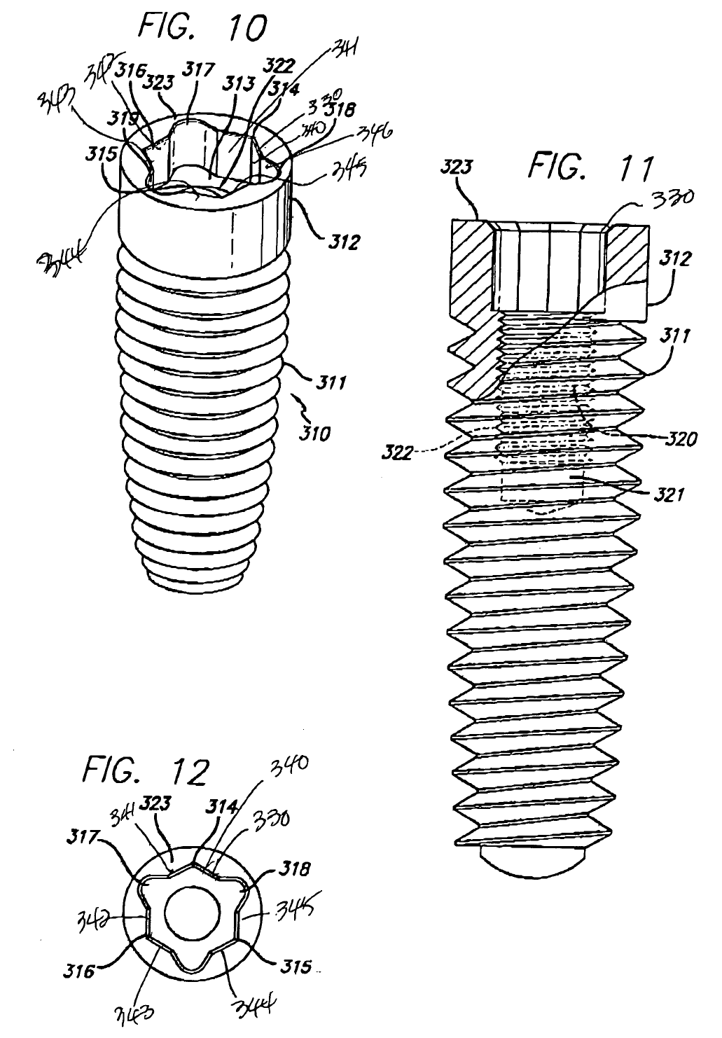

FIG. 10 shows endosseous dental implant 310 with external threading 311 over more than half the length of the external surface of implant 310, and with upper unthreaded external body portion 312. Together, external body portions 311 and 312 comprise the entire external body portion of implant 310. At the top of implant 310 is top surface 323. Below top surface 323 and internal to implant 310 is internal cavity or shaft 322. Opening 313 in top surface 323 of implant 310 leads inwardly and downwardly to internal cavity or shaft 322. At the edge of opening 313 is bevel/chamfer 330, which extends all around opening 313, but could extend only partly around opening 313. Cavity 322 includes (See FIG. 2) threaded portion 320, and, below portion 320, unthreaded portion 321. Threaded portion 321 terminates in passage 322 inside implant 310.

Substantially entirely below top surface 323 are internal wrench-engaging surfaces 340-346. These surfaces include sides 340, 341, 342, 343, 344, 345, and 346, and the points formed by these sides, form a multi-pointed wrench-engaging surface, and are adapted to receive and engage alternate points of a hex-shaped or other wrench-engaging tool for insertion of implant 310 into an opening or bore formed in the jawbone of a patient by threading or screwing implant 310 into such an opening or bore.

Also internal to implant 310 are tri-lobed abutment-engaging surfaces 317, 318, and 319, which are formed in substantially the same plane (or substantially above or below the plane) within which sides 340-346 lie. These tri-lobed surfaces have rounded surfaces which lie within an area that is substantially greater than or smaller than the area within which sides 340-346 lie, and/or than the area occupied by the internally threaded portion 320. Tri-lobed surfaces 317, 318, and 319, and bevel/chamfer 330, are adapted to receive and engage an abutment, and may therefore be denoted abutment-engaging or adapter-engaging surfaces. The external threading 311 on the external surface of implant 310 may be a multiple-lead thread, e.g. a double or triple lead thread, as described in U.S. Pat. No. 5,591,029, columns 14 and 15, or a combination of single lead and multiple-lead threads.

One advantage of the multi-pointed/slotted wrench-engaging surfaces is that an insertion tool can, in preferred embodiments, fit frictionally into the points or apexes or slots of the wrench-engaging surfaces, permitting a dental professional to carry and insert the implant properly and precisely in an opening or bore formed in the jawbone of a patient.

One advantage of the tri-lobed surfaces is that a dental professional has good tactile sense to assure full seating when inserting an abutment, adapter or connector into this surface. Furthermore, the mating, rounded surfaces of the tri-lobed abutment connection provide adequate material thickness to withstand rotational and tipping forces during mastication.

One advantage of the non-circular bevel all around, or partly around, the opening to the internal shaft, where present, is to help center the abutment, thus facilitating initial alignment of the tri-lobed surfaces. Another advantage is to provide for engagement of a mating, beveled surface on the abutment, preventing rotational movement of the abutment when fully seated in the implant and held in place by a fixation screw.

1. An endosseous dental implant comprising:
a body portion having at least part of its external surface threaded and an internal shaft or cavity comprising multi-pointed/multi-sided or multi-slotted wrench-engaging surfaces, tri-lobed surfaces and an internally-threaded portion, said internal shaft or cavity beginning at an opening in the top surface of said implant and ending inside said body portion.

2. The endosseous dental implant of claim 1 wherein said body portion is externally threaded over substantially its entire length.

3. The endosseous dental implant of claim 1 or claim 2 wherein said wrench-engaging surfaces lie in substantially the same area in said shaft or cavity, and wherein each of the points or slots of said wrench-engaging surface lies between two of the lobes of said tri-lobed surface.

4. The endosseous dental implant of claim 1 or claim 2 wherein said external surface of said body portion is partly threaded and, at or near the top of said dental implant, is unthreaded.

5. The endosseous dental implant of claim 1 or claim 2 wherein said internal shaft or cavity extends downwardly into said body portion from said opening at the top surface of said dental implant.

6. The endosseous dental implant of claim 1 further comprising a non-circular chamfer or bevel formed partly or entirely around said opening.

7. An endosseous dental implant of claim 1 wherein the multiple points and sides represent the points and sides of an isosceles triangle.

8. An endosseous dental implant of claim 1 wherein the multiple points and sides represent the alternate points and sides of a hexagon of equal length sides.

9. An endosseous dental implant of claim 1 further comprising a non-circular bevel or chamfer formed at the junction of the top surface of said implant and the tri-lobed surfaces.

10. An endosseous dental implant of claim 1 further comprising a non-circular bevel or chamfer formed at the junction of the top surface of the implant and the multi-pointed, multi-sided wrench-engaging surfaces or multi-slotted wrench-engaging surfaces.
